(19) United States
(12) Patent Application Publication
(10) Pub. No.: US 2012/0264856 A1
(43) Pub. Date: Oct. 18, 2012

(54) FLAME-RETARDANT THERMOPLASTIC MOLDING COMPOSITION

(75) Inventors: Siqi Xue, Shanghai (CN); Alexander König, Bruchsal (DE); Sachin Jain, Jalgaon (IN)

(73) Assignee: BASF SE, Ludwigshafen (DE)

(21) Appl. No.: 13/446,069

(22) Filed: Apr. 13, 2012

Related U.S. Application Data
(60) Provisional application No. 61/475,676, filed on Apr. 15, 2011.

(30) Foreign Application Priority Data
Apr. 15, 2011 (EP) 11162549.7

(51) Int. Cl. C08L 67/02; C08K 13/02

(52) U.S. Cl. 524/101

(57) ABSTRACT

The invention relates to a thermoplastic molding composition free from halogens and from rare earth metals. The composition contains a polyalkylene terephthalate; a polyolefin selected from the group of polyethylene, polypropylene, polypropylene copolymers and mixtures of these; a flame retardant selected from the group of nitrogen-containing compounds, phosphorus-containing compounds and mixtures of thereof; and a reinforcing agent; and optionally another additive. The invention further relates to the use of the thermoplastic molding composition of the invention for producing fibers, foils or moldings, and also to fibers, foils or moldings which contain the thermoplastic molding composition of the invention. The invention further relates to the use of the thermoplastic molding composition as coating means.

The invention relates to a thermoplastic molding composition free from halogens and from rare earth metals and comprising

A) from 40 to 60% by weight of a polyalkylene terephthalate
B) from 0.01 to 10% by weight of a polyolefin selected from the group of
b1) polyethylene
b2) polypropylene
b3) polypropylene copolymers
and mixtures of these;
   C) from 10 to 30% by weight of a flame retardant selected from the group of
c1) the nitrogen-containing compounds
c2) the phosphorus-containing compounds
and mixtures of these;
   D) from 0.01 to 60% by weight of a reinforcing agent;
   E) from 0 to 50% by weight of another additive
   where the total of the proportions by weight is 100% by weight based on the thermoplastic molding composition.

The invention further relates to the use of the thermoplastic molding composition of the invention for producing fibers, foils or moldings, and also to fibers, foils or moldings which comprise the thermoplastic molding composition of the invention. The invention further relates to the use of the thermoplastic molding composition as coating means.

Preferred embodiments can be found in the claims and in the description. Combinations of preferred embodiments are within the scope of the present invention.

The requirement for flame-retardant molding compositions is of growing interest, and there is a particular demand for compositions which are free from additions which could be hazardous to the environment and to humans. At the same time, said molding compositions are intended to meet stringent technical specifications.

The specification KR 10 2007 0 117 410 discloses molding compositions comprising polyalkylene terephthalate and polyolefin. Hydroxide salts are used as flame retardants.

The documents JP 11 335 531, JP 11 335 535 and JP 11 335 534 also disclose molding compositions comprising polyalkylene terephthalate and polyolefin. The molding compositions disclosed therein comprise red phosphorus as flame retardant.

CN 101 434 727 discloses molding compositions comprising a halogen-free flame retardant, comprising a polyalkylene terephthalate and a polyolefin.

The specification CN 101 445 650 discloses molding compositions which comprise a polyalkylene terephthalate and a polyolefin. Said molding compositions comprise rare earth metal salts. The rare earth metal salts are added in small amounts as nucleating agents.

It was an object of the present invention to develop a molding composition which has good processability and at the same time exhibits a flame-retardant effect. A further aim was to provide a molding composition which has high tracking resistance. The molding composition should moreover have minimum intrinsic color.

However, the molding composition should be halogen-free, in particular chlorine- and bromine-free. The molding composition should moreover comprise neither red phosphorus nor rare earth metal salts.

The object is achieved by using a thermoplastic molding composition described in the introduction.

The thermoplastic molding composition of the invention is halogen-free. The definition of halogen-free in this context corresponds to the definitions of the “International Electrotechnical Commission” (IEC 61249-2-21) and of the “Japan Printed Circuit Association” (JPCA-ES-01-1999), which define halogen-free materials as materials which are very substantially chlorine- and bromine-free.

The thermoplastic molding composition moreover comprises no rare earth metals, such as lanthanum or cerium.

A thermoplastic molding composition of the invention in particular comprises halogen-free flame retardants.

Component A) of the thermoplastic molding composition of the invention is a polyalkylene terephthalate. This term also covers mixtures of polyalkylene terephthalates of different structure and/or chain length.

For the purposes of the invention, the term polyalkylene terephthalate is not restricted to compounds comprising terephthalate. The polyalkylene terephthalate component can therefore also comprise at least one acid differing from terephthalic acid.

Said acid can derive from structures which have, in the main chain, an aromatic ring which derives from an aromatic dicarboxylic acid. The aromatic ring can be an unsubstituted or substituted ring. Available substituents are inter alia C₁- to C₄-alkyl groups such as methyl, ethyl, isopropyl, n-propyl- and n-butyl, isobutyl, and tert-butyl groups or fluorine.

Preferred dicarboxylic acids are substituted, or in particular unsubstituted, 2,6-naphthalenedicarboxylic acid, terephthalic acid and isophthalic acid, or a mixture thereof. Among these, preference is given to terephthalic acid or isophthalic acid or a mixture thereof. Polyalkylene terephthalates comprise, alongside the moieties which derive from appropriate dicarboxylic acids, aliphatic hydrocarbon moieties, where these derive from the appropriate alkylenediols. The alkylenediols can be branched or unbranched, i.e. linear, alkylene diols. Branched polyalkylene terephthalates comprise branched hydrocarbon moieties, whereas linear polyalkylene terephthalates comprise unbranched hydrocarbon moieties. The thermoplastic compositions of the invention preferably use linear polyalkylene terephthalates. Among the alkylenediols, preference is given to diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol, or neopentyl glycol or any mixture of these.

In one preferred embodiment of the invention, component A can comprise polyethylene terephthalate, polypropylene 1,3-terephthalate, polybutylene 1,4-terephthalate, polyethylene naphthalate, polybutylene 1,4-naphthalate, polypropylene 1,3-terephthalate, poly(cyclohexanedimethanol terephthalate), or a mixture of these, where component A comprises from 5 to 20% by weight of an acid differing from terephthalate.

Said polyalkylene terephthalates generally have an intrinsic viscosity of from 0.4 dL/g to 2.0 dL/g measured in phenol/carbon tetrachloride (1/1 ratio by volume). The polyalkylene terephthalates generally have an average molar mass of from 5000 to 130 000 g/mol (Mw) (determined by means of gel permeation chromatography in chloroform/hexafluoroisopropanol (5/95, ratio by volume) at 25° C. by measurement against a polystyrene standard).

The thermoplastic molding composition in the invention comprises, as component B), a polyolefin composed of repeat units which comprise ethylene and/or propylene, where polar functional groups are excluded. Mixtures of said polyolefins of differing chain length are included in the invention here.

Polar functional groups are any of the functional groups within incorporated monomer units which include atoms other than carbon and hydrogen. The polyolefin used in the invention therefore consists essentially of the monomer units ethylene and/or propylene, and exclusions here cover units comprising comonomers and/or functional groups and also cover unsaturated groups. Component B) is therefore composed of saturated aliphatic repeat units which are composed of carbon and hydrogen.

However, the polyolefin of component B) can comprise conventional branching points, and also a small amount, in particular up to 2% by weight, of further monomer units composed of carbon and hydrogen. The polyolefin of component B) can therefore comprise small amounts (i.e. in particular up to 2% by weight based on the polyolefin) of other monomer units such as those which derive from 1-butene, 1-pentene, 1-hexene, 1-heptene, or 1-octene, or 4-methyl-1-pentene.

The thermoplastic molding composition therefore comprises, as component B), at least one linear or branched polyolefin consisting essentially of repeat units selected from ethylene and propylene.

Component B) is preferably selected from the group of the polyethylenes, polypropylenes and copolypropylenes and mixtures of these. It is preferable that component B) is a polypropylene and/or a poly(propylene-ethylene).

For the purposes of the present invention where the term polyethylene is used, this means a homopolymer of ethylene. The polyethylene b1) can also be a mixture of homopolymers of differing structure and/or chain length.

The usual melt flow index of the polyethylene b1) used (MFR measured at 190° C., 2.16 kg) is from 0.1 g/10 min to 100 g/10 min, preferably from 2 g/10 min to 50 g/10 min. The molar mass (Mw) of the polyethylene (b1) is typically from 85 000 to 900 000 g/mol, preferably from 95 000 to 750 000 g/mol (determined by means of high-temperature GPC in trichlorobenzene against a polystyrene standard at 130° C.). The density of the polyethylene is from 0.850 g/cm³ to 0.925 g/cm³, preferably from 0.870 g/cm³ to 0.925 g/cm³ (measured by means of immersion methods to DIN EN ISO 1183-1).

For the purposes of the present invention where the term polypropylene is used, this means a homopolymer of propylene, and this can have branches, in particular linear branches. The polypropylene b2) can also be a mixture of homopolypropylene of differing structure and chain length.

The usual melt flow index of the polypropylene b2) (MFR measured at 230° C., 2.16 kg) is from 0.1 g/10 min to 100 g/10 min, preferably from 2 g/10 min to 50 g/10 min. The molar mass (Mw) of the polypropylene is typically from 85 000 to 900 000 g/mol, preferably from 95 000 to 750 000 g/mol (determined by means of high-temperature GPC in trichlorobenzene against a polystyrene standard at 135° C.). The density of the polypropylene is from 0.850 g/cm³ to 0.925 g/cm³, preferably from 0.870 g/cm³ to 0.925 g/cm³ (measured by means of immersion methods to DIN EN ISO 1183-1).

The copolypropylene b3) is preferably a random copolymer or a mixture of random copolymers of differing structure and/or chain length.

The copolymer b3) is in particular composed of propylene and ethylene and also of up to 2% by weight of other C₃-C₂₀ alkenes, comprising 1-butene, 1-pentene, 1-hexene, methyl-1-butene, methyl-1-pentene, 1-octene, 1-decene, and mixtures of these.

A preferred copolypropylene b3) is copoly(propylene-ethylene) produced from propylene and ethylene. The propylene content in this copoly(propylene-ethylene) b3) can be from 75 to 98% by weight, preferably from 85-95% by weight. The ethylene content in this copoly(propylene-ethylene) can be from 2-25% by weight, in particular from 5-15% by weight.

The usual melt flow index of the copolypropylene b3) used (MFR measured at 230° C., 2.16 kg) is from 0.1 g/10 min to 100 g/10 min, preferably from 2 g/10 min to 50 g/10 min. The molar mass (Mw) of the copolypropylene is typically from 85 000 to 900 000 g/mol, preferably from 95 000 to 750 000 g/mol (determined by means of high-temperature GPC in trichlorobenzene against a polystyrene standard at 135° C.). The density of the copolypropylene is from 0.850 g/cm³ to 0.925 g/cm³, preferably from 0.870 g/cm³ to 0.925 g/cm³ (measured by means of immersion methods to DIN EN ISO 1183-1).

The polyolefins used in the invention are obtainable via polymerization of at least one of the monomers ethylene and propylene. Methods for this are known to the person skilled in the art.

The thermoplastic molding composition of the invention also comprises a flame retardant C) selected from the group of the nitrogen-containing compounds c1), of the phosphorus-containing compounds c2), and of mixtures thereof.

The thermoplastic molding composition of the invention can comprise, from the group of the nitrogen-containing compounds (c1) a halogen-free compound from the group of the nitrogen-containing heterocycles having at least one nitrogen atom. The thermoplastic composition can also comprise mixtures of the nitrogen-containing heterocycles having at least one nitrogen atom.

Among the flame retardants that are preferably suitable in the invention is melamine cyanurate. Melamine cyanurate is a reaction product of preferably equimolar amounts of melamine, formula (I) and cyanuric acid or isocyanuric acid, formula (Ia) and (Ib).

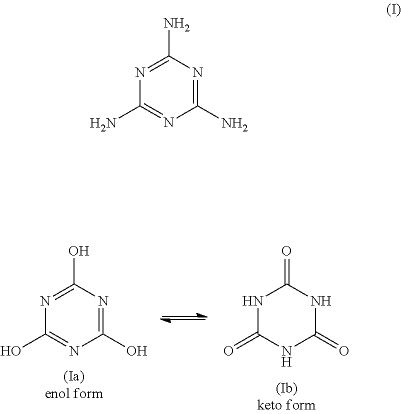

Melamine cyanurate can by obtained by way of example via reaction of aqueous solutions of the starting compounds at from 90 to 100° C.

Further suitable compounds (often also termed salts or adducts) are melamine, melamine borate, and melamine oxalate. Mixtures of said salts can also be used. However, use of salts of nitrogen-containing heterocycles having at least one nitrogen atom and rare earth elements is excluded.

The term nitrogen-containing flame retardants also covers those described in WO 2002/96976.

Compounds suitable here are melamine phosphate prim., melamine phosphate sec. and melamine pyrophosphate sec., melamine neopentyl glycol borate and polymeric melamine phosphate (CAS No. 56386-64-2).

Suitable guanidine salts are

| | CAS No. |
|---|---|
| G carbonate | 593-85-1 |
| G cyanurate prim. | 70285-19-7 |
| G phosphate prim. | 5423-22-3 |
| G phosphate sec. | 5423-23-4 |
| G sulfate prim. | 646-34-4 |
| G sulfate sec. | 594-14-9 |
| Guanidine pentaerythritol borate | N.A. |
| Guanidine neopentyl glycol borate | N.A. |
| Urea phosphate green | 4861-19-2 |
| Urea cyanurate | 57517-11-0 |
| Ammelin | 645-92-1 |
| Ammelid | 645-93-2 |
| Melem | 1502-47-2 |
| Melon | 32518-77-7 |

For the purposes of the present invention, examples of compounds are intended to include benzoguanamine itself and its adducts or salts, and also the derivatives substituted on nitrogen and their adducts or salts.

Ammonium phosphate is also suitable. Ammonium polyphosphate (NH₄PO₃)ₙ where n is approximately from 200 to 1000, preferably from 600 to 800, is also suitable, as is tris(hydroxyethyl) isocyanurate (THEIC) of the formula II

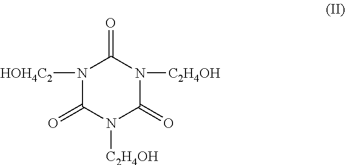

Benzoguanamine compounds of the formula III are also suitable

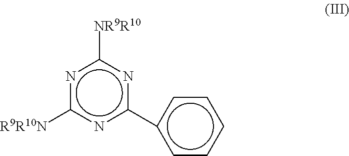

where R⁹ and R¹⁰ are straight-chain or branched alkyl moieties having from 1 to 10 carbon atoms, preferably hydrogen, and adducts of these with phosphoric acid, boric acid, and/or pyrophosphoric acid are particularly suitable.

Preference is also given to allantoin compounds of the formula IV

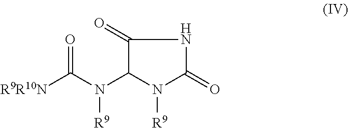

where the definitions of R⁹ and R¹⁹ are those stated in formula III, and also to salts of these with phosphoric acid, boric acid and/or pyrophosphoric acid, and also to glycolurils of the formula V or salts of these with the abovementioned acids

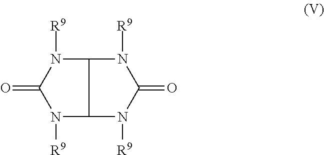

where the definition of R⁹ is as mentioned in formula III.

The cyanoguanidine (formula VI) that can be used in the invention is obtained by way of example via reaction of calcium cyanamide with carbonic acid, whereupon the resultant cyanamide dimerizes at pH from 9 to 10 to give cyanoguanidine.

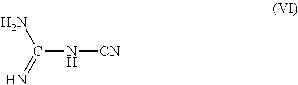

Particularly suitable nitrogen-containing compounds (c1) are compounds from the group of the nitrogen-containing heterocycles having at least one nitrogen atom.

The thermoplastic molding composition can comprise, as phosphorus-containing compound (c2), a phosphinic salt of the formula (VII) and/or diphosphinic salts of the formula (VIII) and/or polymers of these. The thermoplastic composition can also comprise mixtures of the phosphorus-containing compound (c2). However, no rare earth metal elements are used as cations.

Just a few examples may be mentioned from the large number of phosphorus-containing compounds that are suitable in the invention.

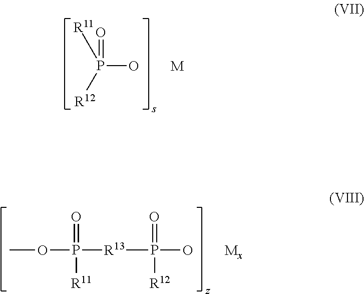

where the definition of the substituents are as follows:
R¹¹ and R¹² are hydrogen or C₁-C₆-alkyl, preferably C₁-C₄-alkyl, linear or branched, e.g. methyl, ethyl, n-propyl, isopropyl, n-butyl, tert-butyl, n-pentyl; phenyl; where at least one radical R¹¹ or R¹² is preferably hydrogen or ethyl and in particular R¹¹ and R¹² are hydrogen or ethyl;
R¹³ is C₁-C₁₀-alkylene, linear or branched, e.g. methylene, ethylene, n-propylene, isopropylene, n-butylene, tert-butylene, n-pentylene, n-octylene, n-dodecylene; arylene, e.g. phenylene, naphthylene;
   alkylarylene, e.g. methylphenylene, ethylphenylene, tert-butylphenylene, methylnaphthylene, ethylnaphthylene, tert-butylnaphthylene; arylalkylene, e.g. phenylmethylene, phenylethylene, phenylpropylene, phenylbutylene;
M is an alkaline earth metal or alkali metal, Al, Zn, Fe, Mg, Ca;
s is a whole number from 1 to 3;
z is a whole number of 1 and 3, and
x is 1 or 2.

Particular preference is given to compounds of the formula VII, in which R¹¹ and R¹² are hydrogen, methyl, ethyl or isobutyl, where M is preferably Ca, Zn, Mg or Al, and very particular preference is given to aluminum diethylphosphinate and aluminum hypophosphite.

Phosphorus compounds of oxidation state +5 which may be used are particularly alkyl- and aryl-substituted phosphates. Examples of these are phenyl bisdodecyl phosphate, phenyl ethyl hydrogenphosphate, phenyl bis(3,5,5-trimethylhexyl) phosphate, ethyl diphenyl phosphate, 2-ethylhexyl ditolyl phosphate, diphenyl hydrogenphosphate, bis(2-ethylhexyl) p-tolyl phosphate, tritolyl phosphate, bis(2-ethylhexyl)phenyl phosphate, di(nonyl)phenyl phosphate, phenyl methyl hydrogenphosphate, didodecyl p-tolyl phosphate, p-tolylbis(2,5,5-trimethylhexyl) phosphate and 2-ethylhexyl diphenyl phosphate. Particularly suitable phosphorus compounds are those in which each radical is aryloxy. Very particularly suitable compounds are triphenyl phosphate and/or resorcinol bis(diphenyl phosphate) and its ring-substituted derivatives of the general formula X (RDPs):

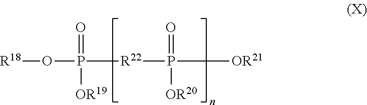

where the definitions of the substituents are as follows:
R¹⁸-R²¹ are aromatic radicals having from 6 to 20 carbon atoms, preferably phenyl, which may have substitution by alkyl groups having from 1 to 4 carbon atoms, preferably methyl,
R²² is a bivalent phenol radical, preferably

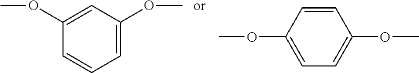

and
n has an average value of from 0.1 to 100, preferably from 0.5 to 50, in particular from 0.8 to 10 and very particularly from 1 to 5.

As a result of the production process, the RDP products currently available commercially are mixtures made of about 85% of RDP (n=1) with about 2.5% of triphenyl phosphate and also about 12.5% of oligomeric fractions in which the degree of oligomerization is mostly smaller than 10.

Phosphorus of valency +0 is not a compound for the purposes of the invention and is therefore not suitable as flame retardant in the invention. The thermoplastic molding composition of the invention is consequently free from red phosphorus.

The thermoplastic molding composition in the invention comprises a fibrous or particulate additive D). It is also possible to use mixtures of differing additives as additive D). Said additive D) can by way of example comprise glass fibers, carbon fibers, aramid fibers, potassium titanate fibers, glass beads, amorphous silica, calcium silicate, magnesium carbonate, kaolins, chalk, powdered quartz, mica, barium sulfate, feldspar, metal hydroxides, metal oxides, similar mineral fillers or a ceramic. Mixtures of the additives D) can also be used.

However, the additive D) comprises no halogen-containing compounds, rare earth metal salts or red phosphorus.

The thermoplastic molding composition of the invention can also comprise an additive E). Mixtures of differing additives can also be used as additive E). The additives E) can be selected from the group of the stabilizers, antistatic agents, nucleating agents, processing aids, impact modifiers, lubricants, and mold-release aids, pigments and antioxidants.

Examples of UV stabilizers that can be used are substituted resorcinols, salicylates, benzotriazoles and benzophenones.

Examples of suitable inorganic pigments are titanium dioxide, ultramarine blue and/or carbon black, while examples of organic pigments that can be admixed are perylenes, phthalocyanines and/or quinacridones. Dyes are also suitable for coloring the thermoplastic composition, examples being nigrosin and/or anthraquinones.

Lubricants and mold-release agents that can be used are long-chain fatty acids (e.g. stearic acid) or salts of these (e.g. Ca stearate). The proportions by weight mostly used of lubricants and mold-release agents are up to 1%, based on the total mass of the thermoplastic molding composition.

Particular plasticizers that can be used are dioctyl phthalate, dibenzyl phthalate, butyl benzyl phthalate, hydrocarbon oils and/or N-(n-butyl)benzene sulfonamide.

However, the additive E) comprises no halogen-containing compounds, rare earth metal salts, or red phosphorus.

Components A), B), C), D) and E) can be mixed in various proportions by weight. The percentage by weight data below are based on the total mass of the thermoplastic composition.

The sum of the individual percentages by weight in a thermoplastic composition is 100% by weight.

Based on total mass, thermoplastic molding compositions of the invention comprise by way of example from 40 to 60% by weight of component (A). The proportions by weight of (A) preferably used can be from 40 to 55% by weight, in particular from 45 to 54% by weight based on the total mass of the thermoplastic molding composition.

It is preferable that the thermoplastic molding compositions of the invention comprise from 0.01 to 10% by weight of component B), based on the total mass of the thermoplastic molding composition. It is particularly preferable that the thermoplastic molding composition of the invention comprises from 0.01 to 8% by weight of component B), in particular from 1 to 8% by weight, based on the total mass of the thermoplastic molding composition.

The proportions by weight added of component (C) are from 10 to 30% by weight based on the total mass of the thermoplastic molding composition. It is preferable to add proportions by weight of from 5 to 30% by weight of component C), in particular from 5 to 25% by weight.

The proportions by weight used of the reinforcing agent (D) are from 0.01 to 60% by weight based on the total mass of the thermoplastic molding composition. In one preferred embodiment, the thermoplastic molding composition comprises proportions by weight of from 15 to 50% by weight of an additive, in particular from 15 to 30% by weight, based on the total mass of the thermoplastic molding composition.

If the material comprises the additive (E), the proportions used thereof can be from 0 to 50% by weight, based on the total mass of the thermoplastic molding composition. In one preferred embodiment, the thermoplastic molding composition comprises proportions by weight of from 1 to 50% by weight of the additive E), in particular from 1 to 45% by weight based on the total mass of the thermoplastic molding composition.

### Examples of Compositions of the Thermoplastic Composition

| Component | Ex. 1 | Ex. 2 | Ex. 3 | Ex. 4 | Ex. 5 | Ex. 6 | Ex. 7 | Ex. 8 | Ex. 9 | Ex. 10 | Ex. 11 |
|---|---|---|---|---|---|---|---|---|---|---|---|
| A | 42 | 48 | 52 | 56 | 52 | 52 | 52 | 52 | 50 | 50 | 50 |
| b1 | 0 | 0 | 0 | 0 | 1 | 0 | 5 | 0 | 0 | 0 | 0 |
| b2 | 3 | 3 | 3 | 3 | 0 | 0 | 0 | 0 | 3 | 3 | 3 |
| b3 | 0 | 0 | 0 | 0 | 0 | 1 | 0 | 5 | 0 | 0 | 0 |
| C | 15 | 15 | 15 | 15 | 15 | 15 | 15 | 15 | 10 | 20 | 15 |
| D | 25 | 25 | 25 | 25 | 25 | 25 | 25 | 25 | 25 | 25 | 30 |
| E | 15 | 9 | 5 | 1 | 7 | 7 | 3 | 3 | 7 | 2 | 2 |

The thermoplastic molding composition of the invention features high tracking resistance (CTI) together with freedom from halogen. The molding composition is flame-retardant. That means that the thermoplastic molding composition complies with the most stringent requirements of the UL 94 flame test and meets the flame test requirements relating to flaming drops. The thermoplastic molding composition also features good mechanical properties, in particular high notched impact resistance. The thermoplastic molding composition also has very little intrinsic color, because it comprises no red phosphorus. The absence of rare earth metal salts is desirable for economic reasons.

### EXAMPLES

### Standards

### ISO 1183

Plastics—Methods for determining the density of non-cellular plastics, German version EN ISO 1183:2004.

### ISO 1133

Plastics—Determination of the melt mass-flow rate (MFR) and the melt volume-flow rate (MVR) of thermoplastics; German version EN ISO 1133:2005.

### UL 94

“Test for flammability of plastic materials for parts in devices and appliances”

### IEC 60112 Edition 4.1 EN

“Method for the determination of the proof and the comparative tracking indices of solid insulating materials”

### Components

### Component A-a

Poly(butylene terephthalate), from BASF SE with intrinsic viscosity 107 mL/g (measured on a 0.5% by weight solution in a phenol/o-dichlorobenzene (1/1) mixture at 23° C.), Ultradur® 82550.

### Component B-a

Polypropylene, from LyondellBasell with density (measured to ISO1183) 0.9 g/cm³ and melt flow index MFR (measured to ISO 1133) 12 g/10 min (230° C., 2.16 kg), Moplen® 501.

### Component B-b

Polypropylene-ethylene), from LyondellBasell with density (measured to ISO 1183) 0.9 g/cm³ and melt flow index MFR (measured to ISO 1133) 15 g/10 min (230° C., 2.16 kg), Moplen 300N.

### Component B-c

Unmodified LDPE with density (measured to ISO 1183) 0.917 g/cm³ and melt flow index MFR (measured to ISO 1133; Plastics—Determination of the melt mass-flow rate (MFR) and the melt volume-flow rate (MVR) of thermoplastics; German version EN ISO 1133:2005) 20 g/10 min (190° C., 2.16 kg), Lupolen® 1800S.

Component c1-a

Melamine polyphosphate, Melapur® 200 from BASF SE.

Component c1-b

Melamine cyanurate, Melapur® MC 25 from BASF SE.

Component c2-a

Aluminum diethylphosphinate, Exolit® OP 1230 from Clariant.

### Component D-a

Glass fibers, diameter 10 μM, standard fiber length 4.5 mm, glass fibers 3786 from PPG.

### Component E-a

Oxidized polyethylene wax lubricant, Luwax® OA5 from BASF SE.

### Processing

The components were extruded in a twin-screw extruder with L/D ratio 18. The compounding temperature during the process was 260° C. Throughput was 10 kg/h. Screw speed was 300 rpm.

The resultant polymer strands were chopped to give pellets. Said pellets were further processed in an injection-molding process.

### Flame Tests

Flame tests were carried out to UL 94. The thickness of the specimens used here was 0.8 mm.

### Tracking Resistance

Tracking resistance tests were carried out to IEC 60112. The dimensions of the test specimens were 60 mm×60 mm×3 mm.

### Examples 1 to 6

Comparative example 1 reveals a thermoplastic molding composition with which no polyolefin was admixed. The examples reveal that the use of a polyolefin increased the tracking resistance (CTI) of the halogen-free molding composition. At the same time the specimen complied with the most stringent requirements of the UL 94 flame test, and complied with the flame test requirements relating to flaming drops. Notched impact resistance was also retained.

| | 1 | | | | | |
|---|---|---|---|---|---|---|
| % | comp | 2 | 3 | 4 | 5 | 6 |
| A-a | 52.2 | 49.2 | 49.2 | 51.2 | 49.2 | 47.2 |
| B-a | — | 3 | — | — | — | — |
| B-b | — | — | 3 | — | — | — |
| B-c | — | — | — | 1 | 3 | 5 |
| c1-a | 3.75 | 3.75 | 3.75 | 3.75 | 3.75 | 3.75 |
| c1-b | 3.75 | 3.75 | 3.75 | 3.75 | 3.75 | 3.75 |
| c2-a | 15 | 15 | 15 | 15 | 15 | 15 |
| D-a | 25 | 25 | 25 | 25 | 25 | 25 |
| E-a | 0.3 | 0.3 | 0.3 | 0.3 | 0.3 | 0.3 |
| UL 94 0.8 mm | V2 | V0 | V0 | V0 | V0 | V2 |
| Flaming drops requirements met? | no | yes | yes | yes | yes | yes |
| Tracking resistance CTI (V) | 550 | 600 | 600 | 575 | 600 | 575 |
| Tensile strength (MPa) | 104 | 101 | 102 | 99 | 96 | 90 |
| Tensile modulus (GPa) | 10.3 | 10.1 | 10.1 | 10.2 | 9.8 | 9.4 |
| Elongation at break (%) | 2.0 | 2.2 | 2.1 | 1.8 | 1.9 | 1.8 |
| Charpy notched impact resistance | 40.9 | 42.1 | 43.0 | 37.1 | 35.5 | 37.5 |
| (kJ/m²) | | | | | | |

1-11. (canceled)

12. A thermoplastic molding composition free from halogens and from rare earth metals and comprising
A) from 40 to 60% by weight of a polyalkylene terephthalate,
B) from 0.01 to 10% by weight of a polyolefin selected from the group of
b1) polyethylene
b2) polypropylene
b3) polypropylene copolymers
and mixtures of these;
C) from 10 to 30% by weight of a flame retardant selected from the group of
c1) the nitrogen-containing compounds
c2) the phosphorus-containing compounds
and mixtures of these;
D) from 0.01 to 60% by weight of a reinforcing agent;
E) from 0 to 50% by weight of another additive
where the total of the proportions by weight does not exceed 100% by weight based on the thermoplastic molding composition.

13. The thermoplastic molding composition according to claim 12, in which A) is a polybutylene terephthalate.

14. The thermoplastic molding composition according to claim 12, in which c2) has been selected from the group of the phosphates, phosphinic salts and diphosphinic salts, and mixtures of these.

15. The thermoplastic molding composition according to claim 13, in which c2) has been selected from the group of the phosphates, phosphinic salts and diphosphinic salts, and mixtures of these.

16. The thermoplastic molding composition according to claim 12, in which c1) is a compound from the group of the nitrogen-containing heterocycles having at least one nitrogen atom.

17. The thermoplastic molding composition according to claim 15, in which c1) is a compound from the group of the nitrogen-containing heterocycles having at least one nitrogen atom.

18. The thermoplastic molding composition according to claim 12, in which c1) is a melamine-containing flame retardant.

19. The thermoplastic molding composition according to claim 15, in which c1) is a melamine-containing flame retardant.

20. The thermoplastic molding composition according to claim 12, in which B) is a polypropylene.

21. The thermoplastic molding composition according to claim 19, in which B) is a polypropylene.

22. The thermoplastic molding composition according to claim 12, in which B) is a poly(propylene-ethylene).

23. The thermoplastic molding composition according to claim 21, in which B) is a poly(propylene-ethylene).

24. The thermoplastic molding composition according to claim 12, in which B) is a polyethylene.

25. The thermoplastic molding composition according to claim 21, in which B) is a polyethylene.

26. A coating means which comprises the thermoplastic molding composition according to claim 12.

27. A process for producing fibers, foils, or moldings which comprises utilizing the thermoplastic molding composition according to claim 12.

28. A fiber, foil or molding comprising a thermoplastic molding composition according to claim 12.
